(19) United States
(12) Patent Application Publication
(10) Pub. No.: US 2008/0293403 A1
(43) Pub. Date: Nov. 27, 2008

(54) MOBILE COMMUNICATION SERVICE BRIDGING

(76) Inventors: Colin Shong Chin Quon, Vancouver (CA); Jeff A. LaPorte, Vancouver (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/752,114

(22) Filed: May 22, 2007

(51) Int. Cl. H04L 12/66; H04Q 7/20

(52) U.S. Cl. 455/426.1; 370/354

(57) ABSTRACT

A system is disclosed that provides functionality for mobile communications service bridging with distributed service gateway call managers that allow application clients running on users' communication devices to be served by any of the available service gateways, preferably in an active-active load balance configuration. Each service gateway instance may bridge the application client to a range of network services such as voice origination and termination services, IM services, messaging services, online community services, IP voice services, and premium services such as multiparty click-to-conference, directory services, and voice mail.

### BACKGROUND OF THE INVENTION

1. Field of the Invention

The present disclosure relates to the field of telecommunications generally. In particular, this disclosure relates to allowing mobile voice, messaging, and/or instant messaging services as an overlay over existing mobile and future broadband wireless networks.

2. Description of the Related Art

Internet users today have access to a plethora of online communications services ranging from Instant Messenger services such as MSN, Yahoo, AIM/ICQ, and Skype to online communities such as Myspace, Friendster, Tagworld, and Facebook. However, when these users are not with their PCs, they are disconnected from their online friends and contacts, or lack the ability to make online-to-online calls, messaging, or instant messaging from mass market mobile phones. In an increasingly ubiquitous mobile society, many of these online users are looking to remain connected to their friends, families, and business contacts by means of their mobile phones.

However, the cost for mobile wireless data is still relatively expensive and the usability of mobile applications on mobile handsets is still lacking given the issues with diverse and inconsistent handset application platforms, handset form factor, battery consumption and CPU processing power. Further, unlike landline networks that have succumbed to the competition of alternate long distance carriers and free VoIP services, the costs of long distance calling and particularly roaming on mobile phones are still exuberant on most mobile networks. Mobile VoIP solutions that are in the market today suffer from limited support on high-end handsets on 3G/Wi-Fi networks or lack of universality on broad range of mass market handsets.

The current state of the art technology for extending and bridging online VoIP and instant messaging communications services can be categorized into 3 groups: (1) Alternate number calling services, (2) Call-back based VoIP services, and (3) Pure mobile VoIP and Instant Messenging services.

1. Alternate Number Mobile VoIP Service

Solution approaches such as Rebtel and ConnectMeAnywhere involve the caller dialing into a local access number (similar to a calling card service) which then automatically bridges the call to a designated callee number but then requires the callee party to hang up and manually dial-back into the bridge. The key technical shortcoming of this approach is that the system can not complete the call—the callee party has the unnatural method of needing to hang up and then call back into a bridge number.

2. Call-Back Based VoIP Service

Call-back based Mobile VoIP services such as Jajah and Mig33 allow the user to enter the caller and callee numbers from the web or on a wireless data connected mobile client. The VoIP service then places a call back to the caller and another call to the callee, and bridges the two calls. The technical shortcomings of this category of mobile VoIP service include an inverted call flow whereby the network calls the user back instead of the normal natural flow of calling out from the handset, hence requires the user to change calling behavior to use a call back service. In some cases, this does not work well with specific phones such as Treo 650 handsets.

3. Pure Mobile VoIP and Instant Messenger Service

Solutions such as AgileMessenger and WebMessenger offer Instant Messenger services for multiple communities such as Yahoo Messenger, ICQ/AIM, and MSN Messenger on mobile phones but do not support voice services except on high-end smartphones or portable PCs. Other clients such as Jajah Mobile support voice services but do not support Instant Messenger. Further, none of these services have the ability to integrate directly with the user mobile's address book to allow users to easily use the mobile IM and mobile VoIP services to directly interact with contacts on their existing personal social network. While the users can use Instant Messenger or mobile VoIP separately, users are unable to select and dynamically switch between modes of communications.

Solutions such as Truphone and Fring allow pure VoIP services to dual-mode Wi-Fi and 3G phones. The key technical drawback of this approach is that the service only works on very few handsets and under very ideal 3G wireless network connections. As a result, this technology is not suitable for mass market service adoption.

### SUMMARY

An embodiment of the present disclosure may be found in EQO Mobile, a mobile phone service from EQO, the assignee of the present disclosure, that enables users to make global calls at some of the lowest international rates available, send global text messages, and chat using all the major Instant Messaging clients such as MSN Messenger, GoogleTalk, Yahoo, AIM, and ICQ. EQO provides a free downloadable mobile software application that is easy to install, and as simple to use as a standard phone address book. The EQO-to-EQO voice calling service allows voice calls between any EQO users as local dial access calls or free VoIP calls. The EQO Out voice calling service allows EQO users to call any phone number similar to SkypeOut but from mass market mobile phones. The EQO service also supports EQO-to-EQO multimedia messaging, EQO Out text messaging, and premium services such as click-to-conference, dynamic call disposition such as redirect to alternate number or voice mail, directory services etc.

A communication service (“Service”) will now be described that embodies various inventive features. Users who are registered with the Service will be referred to as “Service Users” and others as “Non-Service Users. The user application client of the Service on a mobile device will be referred to as “Mobile Client”.

The preferred user interface to the Service is the Mobile Client comprising of a Service addressbook on the user mobile phone. The contacts on the Service addressbook can be imported from the Service user phone's existing phone book or can be manually added to the Service addressbook by the Service user or added through invitations other Service users and Non-Service users. From the Service addressbook, a Service user can initiate calls and send messages to other Service and Non-Service users, chat using instant messaging on all the major IM networks, and use other value-added services such as conferencing and directory services.

One inventive element of the Service for voice calling between the first Service user and second or additional Service users is a Service call request from the first Service caller to one or more Service callee(s). The preferred call flow is for the Service caller party to set up the initial call leg from the Service caller user device either directly through a VoIP session such as a SIP (Session Initiation Protocol) UA or connect to the Service preferably via forward dialing access to a PSTN service access line. In most cases, the call leg for the Service caller involves a local terminated circuit switched call from the Service caller's mobile phone to a local access number provided by the Service, thereby allowing the Service caller to connect to the Service as a local call. The Service uses the Service caller's mobile MSISDN (Mobile Station International ISDN number) arriving at the Service local access point to link the Service caller into the Service. Once the Service caller is connected to the Service, an call request is sent to one or more Service callee parties as specified by the Service caller.

For each specified callee, the process flow then proceeds as follows. The Service callee is alerted on the respective callee party Service application client. If the Service callee party accepts the Service call request, the callee party application client either establishes a VoIP media session or initiates a circuit switched call from the callee party mobile phone to a local access number provided by the Service, thereby allowing the Service callee to connect to the Service as a local call. The Service uses the Service callee's mobile MSISDN arriving at the Service local access point to link the Service callee into the Service. Once the Service callee is connected to the Service, the Service provides the connection tone and/or announcement, and bridges the voice call legs between the Service caller and Service callee. Other variants of the call flow are possible such as a call back rather than a call forward circuit switch connection.

The flow of a Service caller calling a Non-Service contact including any PSTN routable telephone number or an offline Service contact proceeds as follows. The Service caller call leg can be similarly setup as noted above from the Service caller user device to the Service. In this flow, the voice media path flows from the Service caller mobile phone, either as pure VoIP media, or as a circuit switched connection to a local access number provided by the Service that is routed through a voice origination service to a Service media server. For the terminating call leg, the service sets up a call termination to the callee party through an interconnect partner such as Global Crossing, and then bridges the first and second call leg through a media resource.

One invention aspect of the Service is an application client that is adapted to run on a mobile device having an interface to a wireless data network, and having an interface to a mobile network that is separate from the wireless data network. The application client is capable of at least: (a) selecting, from a plurality of available service gateways, a particular service gateway with which to establish a connection; (b) establishing a connection over the wireless data network with a selected gateway; and (c) sending signaling information to the selected service gateway over said connection to set up a voice call over the mobile network. The application client may be capable of using a pseudo-random selection algorithm to select from the plurality of service gateways, and/or may be capable of using load balancing information to make this selection.

Another inventive aspect of this Service is that the Service user can change a service access profile when roaming of the home serving area. For instance, if a user from Vancouver, Canada travels to London, UK, the user can switch to a different SIM card, and change the access profile on the user's Service application client. In this example, instead of accessing the Service through a local access number in Vancouver while at home, the Service provides the user with local access to a number in London. In all these flows, all calls can be either accessed through a local access number or the media carried through a IP connection.

Service user can use the Service Mobile Client to send notification request to the Service callee through the Service. This notification can be encapsulated in a number of transport mechanisms such as SMS. For example, if the Service callee is offline, the Service caller can send a “nudge” notification to the Service callee, and base on the notification, the Service callee party can go online so that Service caller and Service callee can initiate online-to-online voice and messaging sessions.

Using a mechanism similar to message notification, a Service user can send multi-media messages to other Service users. The multi-media message from the message originator is delivered over, as one example, an IP connection from the Service user's Mobile Client to the Service, and then the Service pushes the message to the receiving party's Service Mobile client, or the receiving party's Service Mobile Client uses polling to retrieve the message. The messages can also be queued for later delivery especially if one or more of the receiving Service users are offline. If the receiving Service party is offline, the originating Service party has the option to request the Service service to terminate the message through alternate delivery mechanism such as SMS from the user's mobile phone or terminated through the Service as a network originated message to the receiving party device. On the receiving party application client, the Service user can see the presence status of the message-originating party and can reply with a message or click to initiate voice or multimedia calls to the message initiator.

Neither this summary nor the following detailed description purports to define the invention. The invention is defined only by the claims.

### BRIEF DESCRIPTION OF THE DRAWINGS

FIG. 1 shows one embodiment of the Service system context.

FIGS. 2 and 3 show examples of one embodiment of call flow between first Service user and second Service user, and a first Service user and a second Non-Service user.

FIG. 4 shows one embodiment of a call flow between a Service user to a SIP IP voice service end point that is registered with the Service or is federated with the Service.

FIGS. 5 and 6 show examples of one embodiment of alternate call flows. The former figure depicts the call flow between the first Service user and second Service server where the call leg between the Service network and the second Service user is via a network initiated call back. The latter figure depicts a call flow of a first Service user to a second Non-Service user or a second Service user who is offline and the Service establishes the call leg from the Service core network with the first Service user via a network initiated call back.

FIG. 7 shows one embodiment of the signaling flow for a call between the first Service user and a second Service user involving some of the service elements encapsulated in the service core shown in FIG. 1.

FIG. 8 shows on one embodiment of the signaling flow for a call between the first Service user and a second Non-Service user or a second Service user who is offline involving some of the service elements encapsulated in the service core shown in FIG. 1.

### DETAILED DESCRIPTION OF THE SPECIFIC EMBODIMENTS

The following description is intended to illustrate specific embodiments and features of the invention, and is not intended to limit the scope of the invention.

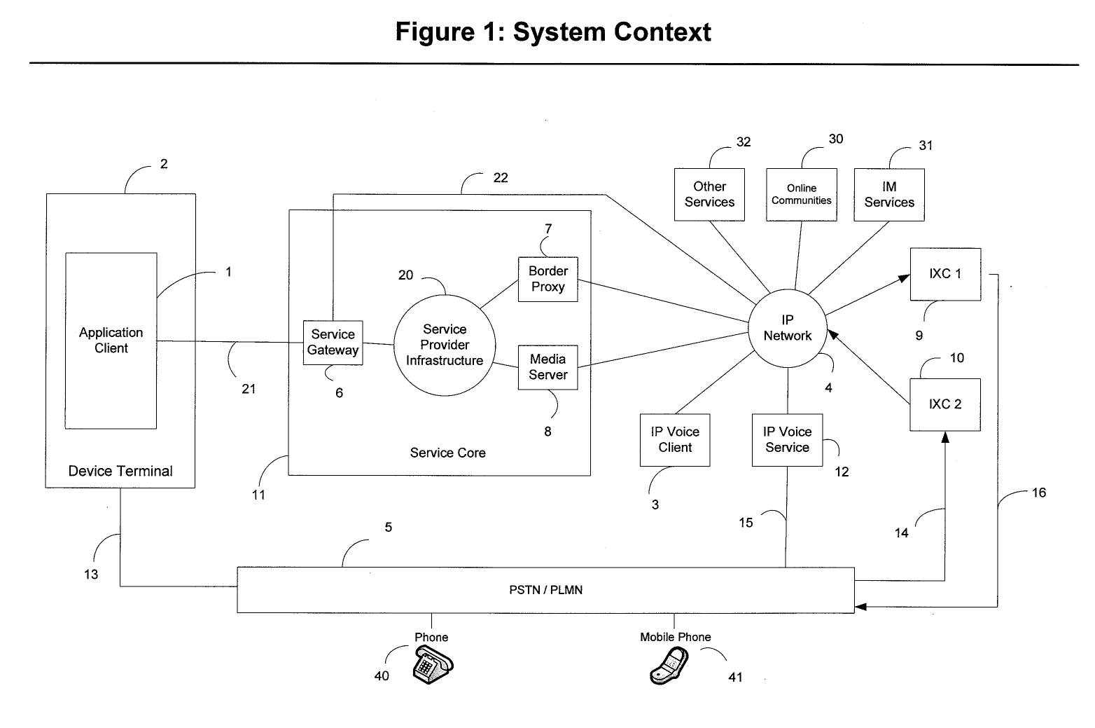

An embodiment of the disclosed system and services is depicted by the system as illustrated in FIG. 1. As shown in FIG. 1, the system comprises an application client 1 hosted on a variety of device terminals 2. Each device terminal 2 is preferably a mobile communications device having a memory which stores, and a processor that executes, the application client 1. The mobile application client 1 may be provided as a free download, and may be adapted to run on a range of application platforms including J2ME, WindowsMobile, Blackberry OS, Symbian, and Palm.

The device terminal 2 is preferably capable of voice services through mobile network interface 13 and data services through network interface 21 on service networks such as GSM/GPRS/EDGE, UMTS, CDMA, WiFi, and WiMAX. (Reference number 21 in FIG. 1 corresponds both to the wireless data network itself, and to the mobile device's terminal's interface to that network. Similarly, reference number 13 corresponds generally to both the mobile network itself and to the mobile device terminal's interface to the mobile network.) The application client 1 may include all of the functionality of the mobile client described in U.S. patent application Ser. No. 11/428,283, filed on Jun. 30, 2006, the disclosure of which is hereby incorporated by reference.

As illustrated in FIG. 1, the application client 1 uses the mobile device terminal's wireless data interface 21 as a signaling interface for communicating with the service gateway 6. The wireless data interface/network 21 is preferably an IP (Internet Protocol) transport network, which is a form packet-switched network. The application client 1 is also capable of using the mobile device terminal's mobile interface/network 13 (which may be a circuit-switch network) to establish voice media connections (voice calls) and to provide other types of voice services.

In another embodiment, the application client 1 and the VoIP media client 3 can be on the same device terminal 2. For example, the device terminal 2 may have a native SIP VoIP client, as is the case with some existing dual mode phones. If present, the native SIP VoIP client can preferably be controlled by the service gateway 6 through SIP signaling.

The application client 1 also provides a user interface for handling various tasks such as a contact list management, messaging, and instant messaging. The application client 1 processes events such as call request, presence status, messaging, and contact synchronization events, based on the digital signals received over the interface 21. As one example, the service gateway 6 may push contact presence information to the application client 1, which may display this information in a visual display of the device terminal's contact list. The application client 1 also transmits client and user event information over the wireless data network 21 to the service gateway 6. The application client 1 has access to the voice and data services on the device terminal 2 through its internal device application programming interfaces (API).

The service core 11 comprises the service gateway 6, the service provider infrastructure 20, and signaling proxy 7 and media resource 8. The service gateway 6 may include all of the functionality of the service gateway described in application Ser. No. 11/428,283, mentioned above. The service gateway 6 is an application server that provides signaling control and service bridging functions between the application client 1 and external service networks such as the PSTN 5 and IP voice service network 12 such as GoogleTalk and Vonage. The service gateway 6 also provides other service bridging functions via interface 22 to IM services network 31 such as MSN, Yahoo, AIM, and QQ, and online communities 30 such as Myspace and Facebook, and other services 32 such as Skype and Short Messaging Service (SMS) interconnect. Interface 22 may be implemented as service proxies or plug-in clients as in the case of Skype, and preferably over an IP transport network. As discussed below, the service core 11 preferably includes multiple service gateways 6, and the application clients 1 are preferably capable of selecting between some or all of these service gateways 6.

The service provider infrastructure 20 in the service core 11 provides various service functions such as the subscriber service database, contact list and presence server, accounting and billing mediation, prepaid servers, service payment web services, SIP registrar and redirect servers, web servers for service fulfillment and/or user provisioning, and network management as well as other operational and business support systems. The various components of the service core 11, such as the presence, media server, redirect, border proxy, and AAA functions, may be embodied in respective code modules executed by one or more general purpose computers.

For voice service, at the signaling layer, the service gateway 6 and service provider infrastructure 20 interface to the public switched telephone network (PSTN) through the signaling border proxy 7, which preferably uses SIP as the signaling protocol. The border proxy 7 may interface to a number of voice origination providers 10, and a number of voice termination providers 9 through network 4. The border proxy 7 may also interface to IP voice services 12 and IP voice clients 3 through network 4. At the media layer, the media server 8 bridges one or multi-party voice media from voice origination network 10 and voice termination network 9, as well as IP voice services network 12 and IP voice clients 3. The media server is not always required and may only be used during certain phases of the call setup such as tones, announcements, conferencing, and voicemail. Preferably, the media server interfaces with voice origination network 10, voice termination network 9, IP voice service network 12 and IP voice client 3 using Real Time Protocol (RTP). All the call legs traversing the Service can be homed to a single media 8 server but can also be re-homed to another media server 8 through mechanisms such as multi-stage SIP INVITE. In addition, the call legs can be distributed and bridged through multiple geographically distributed media servers 8. For redundancy and scalability, there can be multiple instances of the media server 8 that can be accessed via DNS SRV and can also be physically distributed geographically across multiple data centers.

A number of service provisioning flow variants are possible. One preferred provisioning flow is for User A to register for the Service, such as at “www.eqo.com,” and to create a Service ID along with a user service profile including the user's name, mobile number, phone model and mobile carrier. Each Service user is associated with a Service identity including a service profile and other IP service identities such as a SIP URI. Upon registration, say for Service user “A”, the Service sends the mobile client download information to User A's mobile device via, e.g., SMS or WAP push, causing the mobile device to retrieve the mobile client via Over-the-Air (OTA). User A may alternatively transfer the client software 1 to the mobile device through a number of means such as Bluetooth, USB, a memory card, or an HTTP download. User A then installs and executes the application client 1 on supported vendor mobile devices (such as Motorola, Nokia, Samsung, and Sony-Ericsson) preferably with, but not limited to, wireless IP connectivity.

The Service mobile application client 1 in a preferred mode imports User A's contacts from the mobile device's existing contact address book, and preferably allows User A to send invitations to one or more of User A's contacts to become members of the Service. From the Service mobile client 1 as installed on a mobile device, User A can add other Service contacts via a number of identifiers such as Service ID or Service contact phone number, or add Non-Service telephone number to the Service mobile addressbook. From the Service addressbook, User A can initiate calls or multi-media messages to other Service users as well as Non-Service users.

In one embodiment of the system as shown in FIG. 1, the application client 1 can programmatically cause the mobile device 2 to connect to a telephone network service 13 to the PSTN 5 or IP voice Service network 12. A variant of this design includes the support of the application client the capability to integrate with a SIP user agent 3 and able to directly set up session as well as support media entirely over an IP interface 4 to a voice interconnect network 9, 10 that can bridge the call to the traditional telephone network 5. The signaling interface 21 is designed based on TCP and uses protocol encoding and scheme that minimizes battery usage and bandwidth on the device terminal 2. If device terminal 2 can not support TCP or users with service plans that do not support TCP transport, alternate transport methods such as an HTTP may be used for interface 21. The exchange of information between the application client 1 and the service gateway 6 over interface 21 can use a number of encryption schemes such as AES, and uses authentication schemes such as kerberos and HTTP digest depending on device and network requirements.

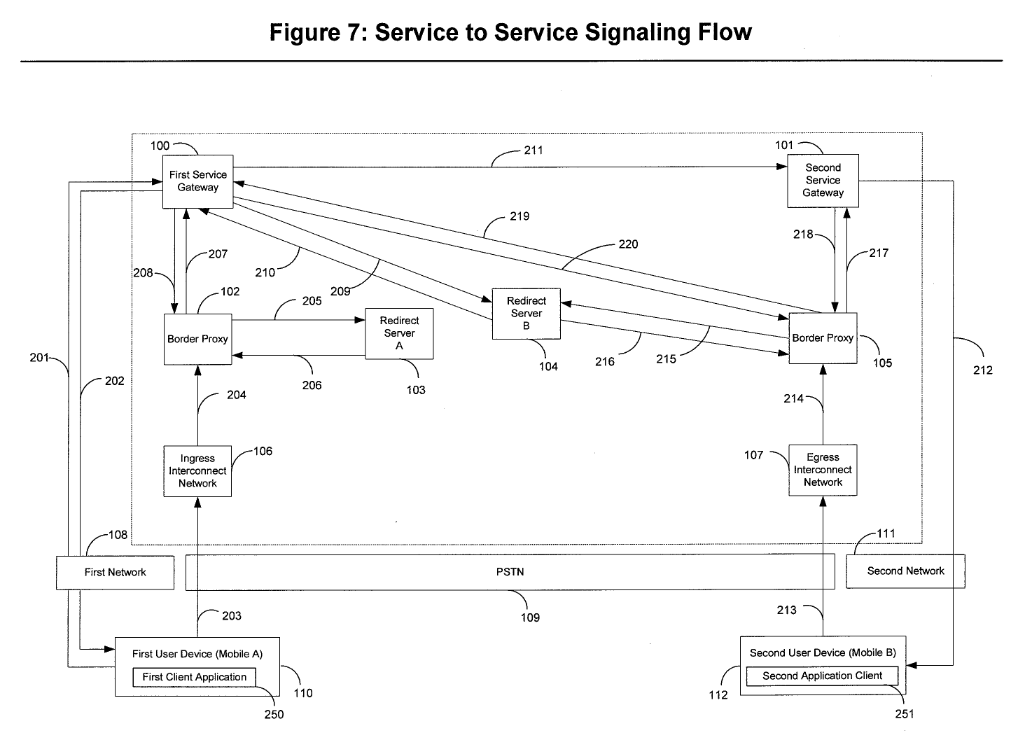

For scalability, multiple instances of the service gateway 6, service provider infrastructure 20 components, border proxy 7 and media server 8 can be deployed on one or more service centers. For redundancy, load balancers such as the Cisco CSS11501 as well as DNS SRV schemes can be used in addition to other application layer redundancy schemes. For instance, multiple instances of the service gateways 6 can be distributed on multiple computing servers for active-active operations for scalability and redundancy. The application clients 1 can be provisioned to be served by any instances of the service gateway 6 so that in the event of failure, the application client 1 can be re-homed/connected to another available instance of the service gateway 6. An embodiment showing two application clients 1 (shown as 250 and 251) and two service gateways 6 (shown as 100 and 101) is shown in FIG. 7. (The term “application client” in this context refers to a particular instance or installation of the application client software 1 on a particular device terminal 1, and the term “service gateway” similarly refers to a particular instance of the service gateway software on a physical computer system.)

In this example of FIG. 7, each application client 250, 251 is provisioned with a “seed” number of service gateways along with the domain name prefix of the service gateways. For instance, the first application client 250 can be initially provisioned, such as in the JAD file of a J2ME client application, to communicate with up to then service gateways 6, each of which has a domain name prefix of “eqopn_x.eqo.com.” These ten service gateways may be implemented on different respective physical servers/machines, some or all of which may be geographically remote from each other. One of these ten service gateways 6 may be set as the default service gateway for this application client 250. If, for example, the first application client 250 attempts to connect to the default service gateway “eqopn_{—}10.eqo.com” but is unsuccessful or receives a connection rejection message, the first application client 250 can then randomly select another service gateway from its “pool” of known gateways. An appropriate pseudo-random selection algorithm may be used by the application clients 1 for this purpose. This design feature reduces the likelihood that a mobile or other device terminal 2 will be unable to use the Service at any given point of time. In other embodiments, the application client 1 may select and attempt to connect to the known service gateways 6 in a particular, pre-specified order, or based on some other criteria (e.g., load data broadcast by the service gateways 6).

As an example, the first application client 250 shown in FIG. 7 may randomly select, and attempt to connect to, the first service gateway 100 as “eqopn_{—}1.eqo.com”. If the first service gateway 100 (which is “eqopn_{—}1.eqo.com” in this example) accepts and responds to first application client 250, then the first service gateway 100 becomes the host for the first application client 250. A similar process applies to the second application client 25 1, which becomes hosted by (i.e., connects to) the second service gateway 101. In the event that the first service gateway 100 experiences an outage such as a maintenance upgrade or hardware or network failure, the first application client 250 can attempt to reconnect to other available service gateways, including the second service gateway 101.

An appropriate discovery protocol may be implemented by the application client 1 and service gateway 6 to allow a given instance of the application client 1 to discover additional service gateways 6 that have become available. For example, once the application client 1 running on a particular device terminal 2 connects to a particular service gateway 6, that service gateway may notify the application client/device terminal of all service gateways 6 that are available. This information may optionally be accompanied by data regarding current load levels of particular service gateways, such that the application client/device terminal directly or indirectly takes service gateway load levels into consideration in selecting a service gateway with which to establish a connection. To implement this feature, the service gateways 6 may periodically broadcast their load levels to the other service gateways.

For battery optimization, the signaling interface between application client 250 and service gateway 100 via the first network 108, if deployed on a mobile phone device 2, is preferably implemented on top of the TCP protocol.

Other service components such as the database and presence server in the service provider infrastructure 20 can be designed for redundancy and scalability through a best practice scheme such as clustering. The service database in the Service Provider Infrastructure 20 contains the Service user subscriber records including the Service ID and password credentials, and pertinent service information such as the user mobile MSISDN. It also provides service configuration data such as support handsets, supported countries, inbound dial access number in each service region, inbound dial number selection priority based on the user mobile MSISDN, and SMS aggregator configuration. This database also acts as storage of Service user messages and Service user invitation requests, and user data elements such as service parameters for widgets that users may paste on online communities such as MySpace.

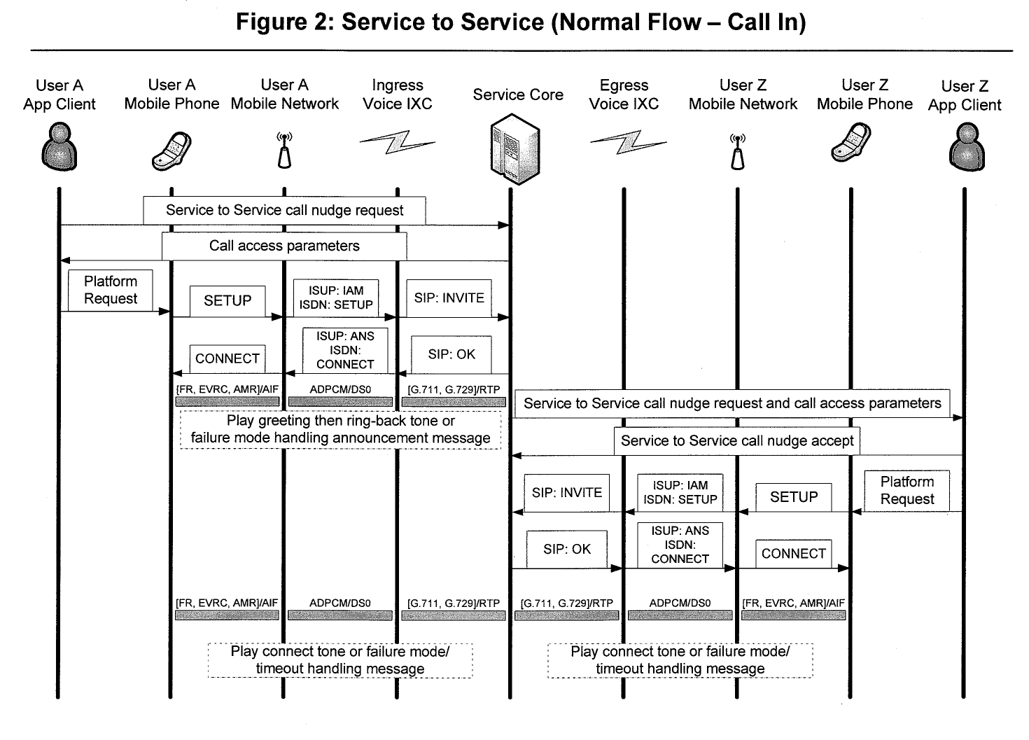

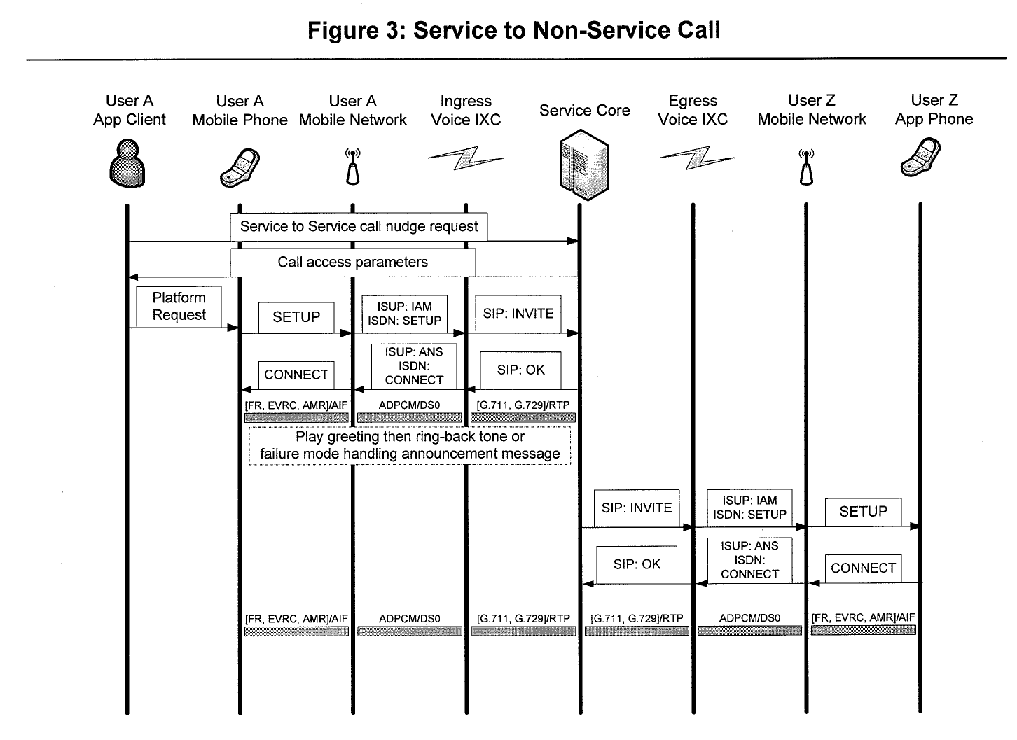

FIG. 2 shows a preferred call flow for calls between a first Service user and a second Service user, and FIG. 2 shows the preferred call flow for calls between a first Service user and a second Non-Service user where the call signaling is carried over an IP connection but the voice media is connected via current generation mobile voice services. FIG. 3 shows a variant where the voice media is also delivered over an IP connection to devices such as dual-mode Wi-Fi or 3G devices supporting a VoIP client such as a SIP user agent. For each of these call flows and possible variants, standard tones and announcements as well as user customizable tones and announcements can be applied to each of the call legs. For example, if Service User A calls Service User Z and if Service User Z rejects the Service call request from Service User A, a customized announcement chosen by Service User Z can be applied to Service User A's call leg such as “I am busy”. Another suitable embodiment of this flow can be applied to conference calls involving multiple caller and callee parties.

Where the voice media involves traditional voice networks, the preferred flow is for the mobile client to connect into a local access number which the Service would transparently connect to the callee party through a bridging service. Such a design approach allows calls between the first Service user and second Service user as local access calls regardless of geographical location. For example, a caller in UK (User A) would pay for local access to a +44 UK local access number, while the callee in China (User Z) would pay for local access to a +86 number without the need to pay for the long distance charges between UK and China. A voice interconnect origination service in the UK would carry the voice media from the UK calling party over VoIP to a Service media server, and similarly, a voice interconnect origination service in China would carry the voice media (voice data packets) from the China calling party over VoIP to the Service media server which then bridges the caller and callee party voice media. The call flow for first Service caller to a Non-Service caller or a Service caller that is offline is conceptually equivalent to the SkypeOut service except it is operated from the user's mobile phone rather than the PC. For instance, a Service caller (User A) in Vancouver, Canada calling a number in China (User Z) would access a local dial access number with NPA-NXX +604 or +778 number through a voice interconnect origination service through a Service media service that bridges the call to terminate to the callee party in China through an interconnect voice termination service.

As shown in FIG. 2, for the call flow between a first Service user and a second Service user, the application client software for User A sends a call request to the service core 11 which then sends a dynamic local dial access number back to the application client 1 of User A if a circuit switch connection is required. If a broadband connection is available, the session establishment from the call originating party User A can be established such as through a SIP initiation session from a IP voice client 3 which may be programmatically integrated with the application client 1 on the same user device 2. The dynamic local access number allows a least cost access method to be configurable and dynamically altered based on routing cost, user preference, time of day, etc. For circuit switch mode operations, the application client for User A initiates a circuit switch call to the local dial access number. A call origination interconnect provider then trunks this call along with the caller ID of User A to the service core 11. If the incoming caller ID accessing the local dial access number matches that of User A that is set in the service core 11, the Service establishes the first call leg, and applies the tones and announcements such as a ringback tone to User A while the Service attempts to set up the second call leg to the callee party User Z.

For the second call leg of call between two Service users, the Service core 11 then pushes the call request from User A to the application client software of User Z. If User Z accepts the call request from User A, and if the broadband wireless IP connection is not available, the client software for User Z initiates a circuit switch call connection to a local dial access number. The call origination interconnect provider then trunks the call to the Service core 11 as the egress call leg. If the caller ID to the egress portion of the call leg matches that of MSISDN of User Z, then the Service core bridges the two half call legs together. Standard tones and announcements such as a connect tone can then be applied to the callee party call leg or all call legs. At this point, there is an end-to-end media flow between User A and User Z.

The call flow between a first Service user and a non-Service user or a second Service user that is offline as shown in FIG. 3 is similar to the flow in FIG. 2 for the first call leg. However, for the second call leg to a non-Service user (any routable telephone number or a federate user from a VoIP service such as SipPhone) or to an Service user who might be offline, the Service core 11 (for a circuit switch mode call) initiates a terminating call leg to a voice termination interconnect provider, which then delivers the call to the callee party User Z. If User Z answers the call, an end-to-end media path is established between User A through the User A mobile provider network through the ingress interconnect service provider to the Service core 11, then through the egress interconnect service provider, and terminate to the mobile service provider of User Z.

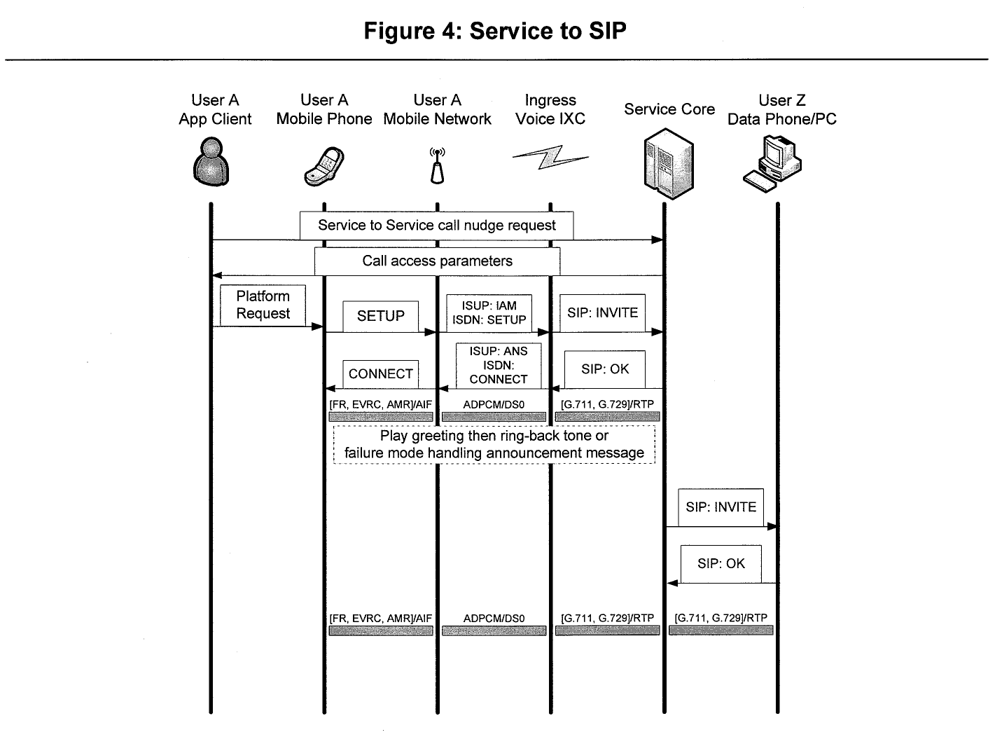

FIG. 4 shows an embodiment of a call between a first Service user and a second Service user or Non-Service user that is a SIP user agent end point. In this flow, the first call leg between the Service user caller can be the same as the first call leg shown in FIG. 2, but the egress call leg to User Z with a native SIP user agent can be delivered via a SIP session over an IP network. In this sample flow in FIG. 4, for the terminating call leg, the Service sends the SIP INVITE request to User Z SIP user agent device. If User Z accepts the session, then an end-to-end media flow is established between User A (in this example using circuit switch mode connection for the media transport) and User Z (in this example using IP as the media transport).

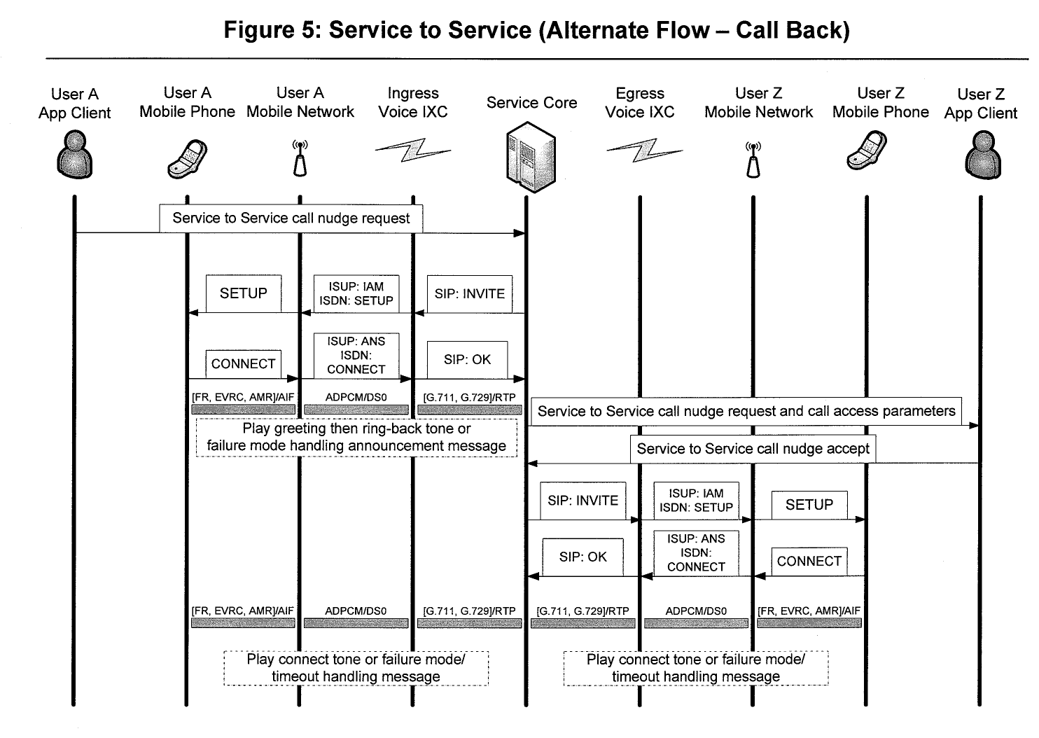

FIG. 5 shows a variant of a call between a first Service user and a second Service user where the ingress call leg from User A is similar to FIG. 1, but the egress call leg is terminated from the Service network to the callee party mobile service via a call back. In this call flow variant between two Service users, when the callee party User Z accepts the call request from User A, the application client for User Z sends the call disposition response to the Service core 11 (other call disposition options such as reject, voice mail, redirect to alternate number are all possible variants) which then (for a circuit switch mode call) initiates a terminating call leg to a voice termination interconnect provider that delivers a call back to the callee party User Z. If User Z answers the call, and end-to-end media path is established between User A and User Z through the following entities: the mobile service provider of User A, the ingress interconnect service provider to the Service core, the egress interconnect service provider, and the mobile service provider of User Z.

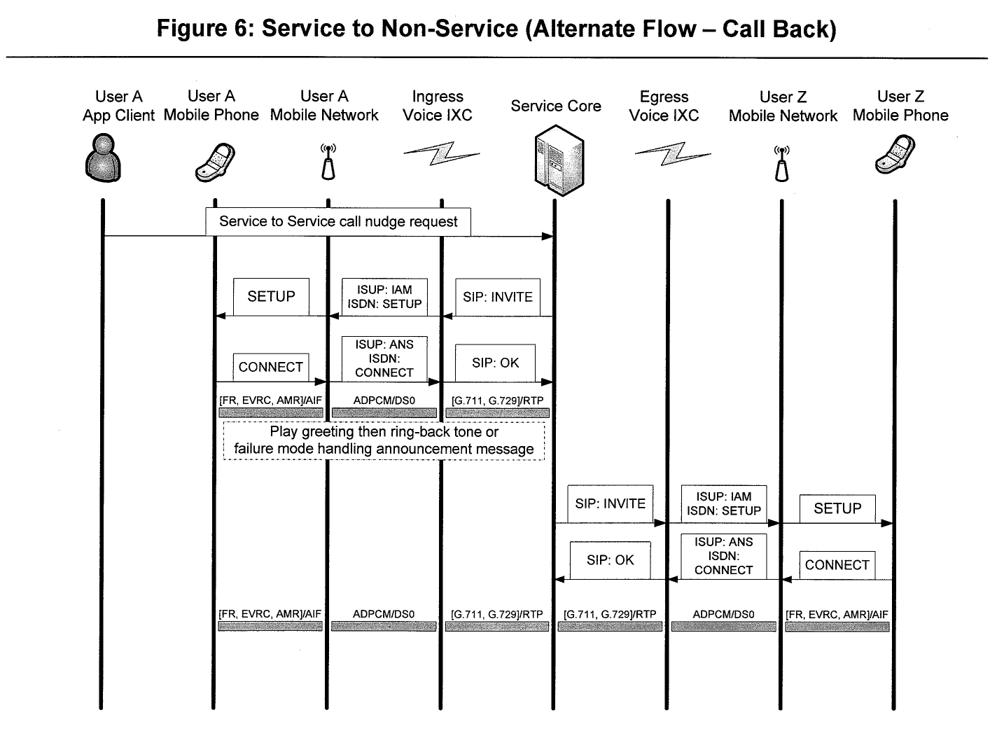

FIG. 6 shows a variant of the call flow between the first Service user and a Non-Service user or a second Service user that is offline. In this particular flow variant, the ingress call leg between the Service core 11 and User A in circuit switch mode is established via a call back. The call flow of either a forward dialing or a call back can be implemented programmatically based on user specified preference or based on service routing rules such as least cost. As shown in FIG. 6, User A initiates a call request to place a call to User Z to the Service core 11. The Service core 11 (for a circuit switch mode call) then initiates the ingress terminating call leg to a voice termination interconnect provider, which then delivers the call to the User A. If User A answers the call, a circuit switch media path is established between User A and the Service core 11. The Service core 11 then places User A on hold and injects the appropriate tones and announcements. Next, the Service core 11 (for a circuit switch mode call) attempts to set up the egress call leg by initiating a terminating call leg to a voice termination interconnect provider, which then delivers the call to the callee party User Z. If User Z answers the call, and end-to-end media path is established between User A through the mobile service provider of User A. This path extends through the ingress interconnect service provider to the Service service core, then to the egress interconnect service provider, and finally to the mobile service provider of User Z. As shown, different combinations of the call flows to FIGS. 2, 3, 4, 5, and 6 are possible.

FIG. 7 shows one embodiment of session control messaging flow of a call between first Service user and second Service user for circuit switch mode operations. In this flow, the service gateway 100 provides the application client 250 on the User A device 110 via data network 108 and interface 201, 202 with the access number to the call origination provider 106. (The service gateways 100, 101 are specific instances of the service gateway 6 shown in FIG. 1, and the application clients 250, 251 are specific instances of the application client 1 shown in FIG. 1.) Next, application client 250 initiates a call from the User A device 110 to the access number of the call origination interconnect provider 106 through the PSTN 109. The call origination provider 106 delivers the call signaling to the border proxy 102, which checks with redirect server 103 for the validity of User A's MSISDN, which is set by the serving service gateway 100. If there is a match, the service gateway 100 then sets up the ingress media call leg of the session with the media resource. The service gateway 100 then sends the call request to the application client 251 of the second Service user. If the second Service user is hosted on a different service gateway 101 (as in FIG. 7), then inter-service gateway messaging 211 is used to relay the call request to the callee party Service user B on user device 112. The egress call leg is then set up similarly from the User B device 112 through the callee party call origination provider 107, which may use a different border proxy 105 and redirect server 104. Though the callee party Service user may be controlled by a different service gateway 101, the caller party service gateway 100 may handle all the call legs of the call session.

The first service gateway 100 and second service gateway 101 may be hosted on different computing servers (physical machines) connected by IP networking. These computing servers may be hosted in different physical locations to provide geographical diversity. Alternatively, the first and second gateways 100, 101 can be hosted on the same physical computing server. The communications interface 211 between the first service gateway 100 and second service gateway 101, and any other service gateway(s) 6 in the system, can be based on a number of messaging schemes including SIP and XML-based message over SOAP.

For simplicity, the media layer is not shown in FIG. 7. At a high level, the media resource for both the ingress call leg and egress call leg (and by extension any additional number of egress call legs) is controlled by the first service gateway 100. The preferred signaling protocol from the service gateways 100 to the media resource, such as a media server, is SIP. The media resource can be directly controlled by the service gateway 100 via the border proxy 208, 105 or the media resource can be provided in the ingress interconnect network and egress interconnect network such as a media gateway residing in the ingress interconnect network and egress interconnect network. The service gateway 100 can use multi-stage SIP invite to re-home the media paths amongst media resources as needed such as tones and announcements and the actual voice media.

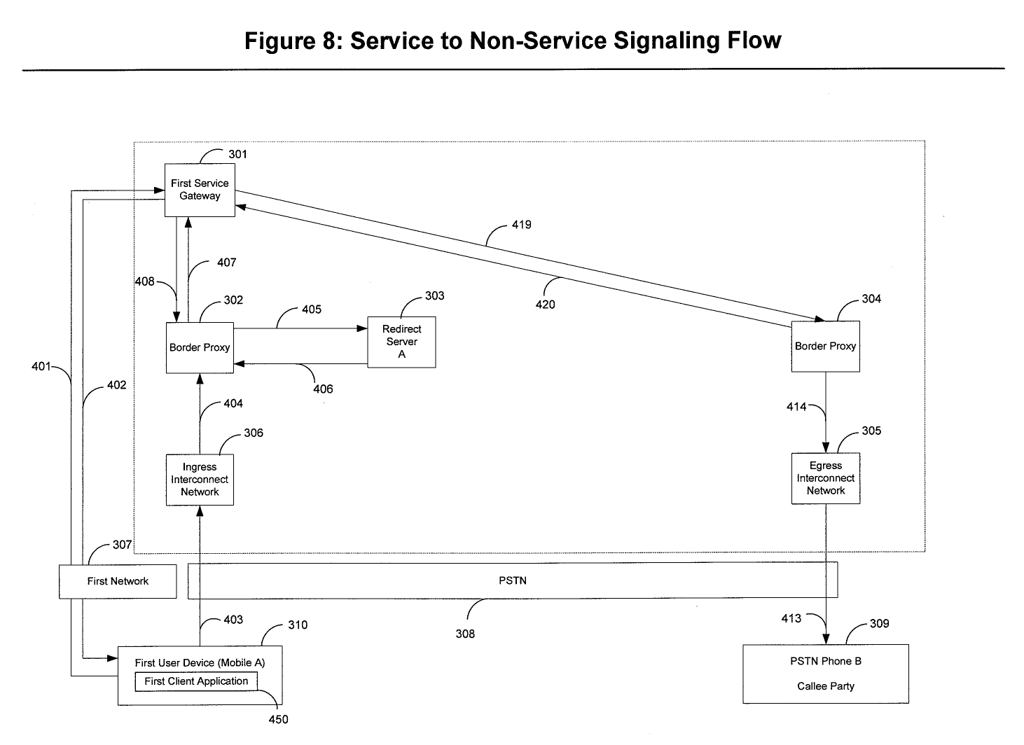

FIG. 8 is an embodiment of a session control message flow for call between the first Service user and a Non-Service user or second Service user that is offline in circuit switch mode operations. The ingress call leg setup is similar to the Service caller party flow illustrated in FIG. 7. In this case, the call setup request from client application 450 via mobile device 310 is sent to serving service gateway 301 via data network 307 and interface 401, 402. Similar to the flow shown in FIG. 7, the ingress call is setup from User A device 310 through PSTN 308 to the call origination provider 306. For the egress call leg terminating the call to the callee party B, instead of the service gateway sending a call request to the callee party, the service gateway 301 initiates a call termination request through a border proxy 304 to a voice interconnect termination provider 305. The selection of the voice interconnect provider can be based on parameters such as cost, time of day, and user preference. Once the caller party 309 answers the call, both the ingress and egress call leg are now established between User A on user device 310 and User B on user device 309. For simplicity, the media layer is not shown in this diagram.

In addition to the functionality described herein, the Service may, in some embodiments, include the various features, components, and functionality described in U.S. patent application Ser. No. 11/314,971 titled “DISTRIBUTED SYSTEM FOR CLUSTERING COMMUNICATIONS DEVICES AND SERVICES AVAILABLE TO A USER” and filed on Dec. 20, 2005, U.S. patent application Ser. No. 11/314,745 titled “DISTRIBUTED SYSTEM FOR SHARING OF COMMUNICATION SERVICE RESOURCES BETWEEN DEVICES AND USERS” and filed on Dec. 20, 2005, U.S. patent application Ser. No. 11/428,283 titled “DYNAMIC AND CONTEXT DRIVEN CALL CONTROL AND SERVICE BRIDGING” and filed on Jun. 30, 2006, and/or U.S. Provisional Patent Application No. 60/814,150, titled “ONLINE COMMUNITY AND IDENTITY EXTENSION TO MOBILE DEVICES” filed on Jun. 16, 2006, the disclosures of which are hereby incorporated in by reference in their entirety.

### Conclusion

The various features described above may be implemented in, and fully automated by code modules executed by general-purpose computing devices, including but not limited to PCs, Personal Digital Assistants, and mobile phones. The code modules may be stored in any type or types of computer storage device or memory. It should be understood that the various steps may alternatively be implemented in-whole or in-part within specially designed hardware.

Although this invention has been described in terms of certain embodiments and applications, other embodiments and applications that are apparent to those of ordinary skill in the art, including embodiments which do not provide all of the features and advantages set forth herein, are also within the scope of this invention. Accordingly, the scope of the present invention is intended to be defined only by reference to the following claims.

What is claimed is:

1. A mobile communications device having a processor, an interface to a wireless data network, and an interface to a mobile network that is separate from the wireless data network, the mobile communications device further comprising:
a memory; and
an application client stored in the memory, wherein the application client, when executed by the processor, causes the mobile communication device to at least: (a) select, from a plurality of available service gateways, a particular service gateway with which to establish a connection; (b) establish a connection over the wireless data network with the selected service gateway; and (c) send signaling information to the selected service gateway over said connection to set up a voice call over the mobile network.

2. The mobile communications device of claim 1, wherein the application client implements a random selection algorithm to select between the plurality of available service gateways.

3. The mobile communications device of claim 1, wherein the application client is configured to receive information about available service gateways from the selected service gateway, and to use said information to subsequently select another service gateway with which to establish a connection.

4. The mobile communications device of claim 3, wherein said information includes, or is derived from, data regarding current load levels of the particular service gateways, such that the application client directly or indirectly takes said load levels into consideration in selecting a service gateway with which to establish a connection.

5. The mobile communications device of claim 1, wherein the wireless data network is an IP packet-switched network, and the mobile network is a circuit-switched network.

6. The mobile communications device of claim 1, in combination with said plurality of service gateways, wherein said plurality of service gateways are capable of communicating with one another to set up and bridge call legs of calls initiated by said application client.

7. A computer storage medium having stored thereon an application client that is adapted to run on a mobile device, said mobile device including an interface to a wireless data network, and including an interface to a mobile network that is separate from the wireless data network, wherein the application client is capable of at least:
(a) selecting, from a plurality of available service gateways, a particular service gateway with which to establish a connection;
(b) establishing a connection over the wireless data network with a selected gateway; and
(c) sending signaling information to the selected service gateway over said connection to set up a voice call over the mobile network.

8. The computer storage medium of claim 7, wherein the application client is capable of using a random selection algorithm to select the service gateway.

9. A method of mobile communications service bridging with distributed service gateway call managers, the method comprising:
a first application client on first user device selecting a first service gateway from a plurality of service gateways known the first application client;
the first application client communicating signaling information over a wireless network to the first service gateway;
a second application client on a second user device communicating signaling information over a wireless network to a second service gateway;
the first service gateway providing call setup information to the first application client and establishing an ingress call leg between the first user device and an ingress call interconnect network and first media resource;
the first service gateway signaling the second service gateway to establish the egress call leg;
the second service gateway providing call setup information to the second application client and establishing an egress call leg between the second user device and an egress call interconnect network and second media resource; and
the first service gateway establishing an end-to-end call session and bridging session media between the first media resource to the first user device and the second media resource to the second user device.

10. The method of claim 9, wherein the first application client uses a pseudo-random selection algorithm to select the first service gateway from said plurality of service gateways.

11. The method of claim 9, wherein the first application uses service gateway load data to select said first service gateway from said plurality of service gateways.

12. The method of claim 9, wherein the first and second application clients communicate said signaling over an IP wireless data network.

13. The method of claim 9, wherein the first user device and second user device are mobile phones with wireless data connectivity.

14. The method of claim 9, wherein the first user device and second user device each include an IP voice services client.

15. The method of claim 14, wherein the IP voice services client is an SIP VoIP client.

16. The method of claim 9, wherein the first media resource and the second media resource are distributed media resources controlled by the first service gateway and second service gateway, respectively.

17. The method of claim 9, wherein the first media resource and the second media resource are controlled by the ingress call interconnect network and the egress call interconnect network, respectively.

18. The method of claim 9, wherein the ingress call interconnect network is capable of doing at least one of the following: (a) originating a call from a PSTN access point to an ingress IP point of presence, (b) terminating a call from an ingress IP point of presence to a PSTN number, (c) routing a call from the ingress IP service end point to an ingress IP point of presence.

19. The method of claim 9, wherein the signaling between a signaling border proxy associated with the first service gateway and the ingress call interconnect network is based on SIP messaging.

20. The method of claim 9, wherein the egress call interconnect network is capable of doing at least one of the following (a) originating a call from a PSTN access point to an egress IP point of presence, (b) terminating a call from an egress IP point of presence to a PSTN number, (c) routing of a call from an egress IP point of presence to the egress IP service end point.

21. The method of claim 9, wherein signaling between a signaling border proxy associated with the second service gateway and the egress call interconnect network is based on SIP signaling.

22. The method of claim 9, wherein the first and second service gateways are geographically remote from each other.

23. The method of claim 9, wherein the second service gateway is adapted to by extended to represent up to N service gateway instances where N is the number of callee parties, and where N is greater than one.

24. The method of claim 1, wherein the method comprises the first application client transmitting call setup signaling information to the first service gateway using a TCP-based protocol.

25. The method of claim 9, wherein the ingress call leg is a voice call let established in a circuit switch mode.

26. The method of claim 9, wherein establishing the ingress call leg comprises initiating a telephone call from the first user device to an ingress call origination interconnect network.

27. The method of claim 9, wherein establishing the ingress call leg comprises initiating a call back from an ingress call termination interconnect network to the first user device.

28. The method of claim 9, wherein establishing the ingress call leg comprises establishing a media session from the first user device to the ingress call origination interconnect network using RTP over an IP network.

29. The method of claim 9, wherein the step of establishing the egress call leg comprises: (a) initiating a telephone call from the second user device to the egress call origination interconnect network; (b) initiating a call back from an egress call termination interconnect network to the second user device; or (c) establishing a media session from the call termination interconnect network to the second user device.

30. The method of claim 9, wherein the method comprises transmitting call access and routing instruction information from the first service gateway to the first application client to cause the first user device to establish a circuit switched voice call leg to the ingress call origination interconnect network.

31. The method of claim 9, wherein the method comprises transmitting MSISDN data associated with the first user device from the first application client to the first service gateway via the wireless network to enable the first service gateway to associate and establish an ingress call leg voice path between the first user device and the ingress call interconnect network.

32. The method of claim 9, wherein the method comprises transmitting call access and routing information from the second service gateway to the second application client to cause the second user device to establish a circuit voice call leg to the egress call origination interconnect network.

33. The method of claim 9, wherein the method comprises transmitting MSISDN data of the second user device from the second application client to the second gateway via the second network to enable the second service gateway to associate and establish an egress call leg voice path between the second user device and the egress call interconnect network.

34. The method of claim 9, wherein the setup of the ingress and egress call legs comprises programmatically selecting between at least the following options for establishing the ingress and/or the egress call leg: (a) placing a telephone call from the voice termination interconnect network to a user device, (b) instructing a user device to place a telephone call to the voice origination interconnect network, or (c) establishing a media session over an IP connection from an IP voice enabled user device to a voice origination interconnect network or another IP voice enabled user device.

35. The method of claim 34, wherein programmatically selecting between options (a), (b), and (c) comprises taking into consideration monetary call rates associated with each such option.

36. The method of claim 34, wherein programmatically selecting between options (a), (b), and (c) comprises taking into consideration a telephone number of the user device.

37. The method of claim 34, wherein programmatically selecting between options (a), (b), and (c) comprises taking into consideration a type of the user device.

38. The method of claim 34, wherein programmatically selecting between options (a), (b), and (c) comprises taking into consideration a user-indicated preference for anonymity.

39. The method of claim 9, wherein the first service gateway and second service gateway provide load balancing in serving the first application client and the second application client.
